(19) United States
(12) Patent Application Publication
(10) Pub. No.: US 2010/0241801 A1
(43) Pub. Date: Sep. 23, 2010

(54) METHOD FOR BACKING UP DATA OF A SERVER MACHINE

(75) Inventors: Chih-Wei CHEN, TAIPEI CITY (TW); Hsiao-Fen LU, TAIPEI CITY (TW)

Correspondence Address: BRIAN M. MCINNIS, 12th Floor, Ruttonjee House, 11 Duddell Street, Hong Kong, HK

(73) Assignee: INVENTEC CORPORATION, TAIPEI CITY (TW)

(21) Appl. No.: 12/479,751

(22) Filed: Jun. 5, 2009

(30) Foreign Application Priority Data
Mar. 18, 2009 (TW) 98108802

(51) Int. Cl. G06F 12/00; G06F 12/16

(52) U.S. Cl. 711/112; 711/162; 711/E12.001; 711/E12.103

(57) ABSTRACT

A method for backing up data of a server machine is provided. The server machine owns an operating system in which a kernel layer and an application layer are defined. When the application layer requests a backup agent at the kernel layer to back up data in the server machine to another server machine, the backup agent first requests the kernel layer to duplicate the data and put the data to a buffer at the kernel layer, and thereafter the backup agent requests the kernel layer to directly read the data from the buffer and transmit the data to the another server machine without being required to send the data back to the application layer.

### RELATED APPLICATIONS

This application claims priority to Taiwan Application Serial Number 98108802, filed Mar. 18, 2009, which is herein incorporated by reference.

### BACKGROUND

1. Field of Invention

The present invention relates to a data backup method. More particularly, the present invention relates to a method for backing up data of a server machine under a Linux operating system.

2. Description of Related Art

With the advent of network technologies, many newly developed products called Internet appliances or information appliances are presented to the market, such as a network-attached storage (NAS) server consisting of a redundant array of independent disks (RAID). Such storage server mostly can be used to directly connect to a network system, so that a remote computer can back up a large quantity of data to the storage server. However, referring to FIG. 1, FIG. 1 is a schematic diagram showing the interaction between an application layer and a kernel layer in a conventional operating system. Besides being used as a data storage area exclusively belonging to a remote computer, such storage server 10 also can be used as an independently-operated remote backup system which also has a random access memory (RAM) and an exclusive embedded operating system 20 and application programs. Certainly, the storage server 10 also has chance to back up a large quantity of data to another storage server 70 at a remote site.

In the operating system 20 of the aforementioned storage server 10, an application layer 30 and a kernel layer 40 are defined. As a result of a protection scheme, the operating system 20 defines a memory space for each of the application layer 30 and the kernel layer 40, and the tools located at the application layer 30 has to use a data-duplicating method to access the data stored in the memory space of the kernel layer 40, which cannot randomly select and access the data stored in the memory space of the kernel layer 40. Thus, when the storage server 10 is desired to back up a large quantity of data to the storage server 70 at the remote site, every time when one of the blocks of data in a disk device 42 is backed up to the storage server 70 at the remote site, a backup tool 31 at the application layer 30 has to use a system call to invoke the hard disk driver 43 to read the block of data and duplicate the block of data to a first buffer 47 (for example, an about 64K buffer) in the memory space of the kernel layer 40, and then to allow the operating system 20 to duplicate the data in the first buffer 47 to a second buffer 32 (for example, an about 64K buffer) in the memory space of the application layer 30. Thereafter, the backup tool 31 again uses another system call to invoke the operating system 20 to duplicate the data in the second buffer 32 to a third buffer 49 (for example, an about 64K buffer) at the kernel layer 40, wherein the third buffer 49 is provided by a connection interface driver 45 associated with a connection interface 44, so that the connection interface driver 45 may back up the data in the third buffer 49 to another storage server 70. Consequently, after many system calls and repeated steps of duplicating the data from the first buffer 47 to the third buffer 49 via the second buffer 32 for all of the blocks of data in the disk device 42, the storage server 10 may complete the procedures of backing up a large quantity of data in the disk device 42.

However, since the motivation for backing up data is generally to duplicate all of the data stored in a specific number of hard disks or file folders of the entire storage server to another remote storage server, thereby preventing data damage or loss. Hence, for quite an immense amount of data in a storage server, there is no doubt that extra system call context switches and steps of duplicating data back and forth between the kernel layer and the application layer will be doubly wasted.

### SUMMARY

In view of the aforementioned shortcomings, the present invention provides a method for backing up data of a server machine by simplifying the procedure for duplicating data back and forth between the kernel layer and the application layer, wherein a buffer provided for the disk driver to put blocks of data is directly used as the buffer required by the driver associated with the connection interface, so as to get rid of the buffer of the application layer for storing the data in the buffer of the kernel layer again, thereby reducing the time for duplicating data back and forth between the kernel layer and the application layer, further improving the efficacy for backing up data in a server machine to another server machine.

According to the above objects, a method for backing up data of a server machine is provided. The server machine owns an operating system having a kernel layer and an application layer. When the application layer requests a backup agent at the kernel layer to back up data in the server machine to another server machine, the backup agent requests the kernel layer to duplicate data in a disk device and put the data in a kernel buffer at the kernel layer; and then the backup agent requests the kernel layer to directly read the data from the kernel buffer and transmit the data to the another server machine.

It is to be understood that both the foregoing general description and the following detailed description are examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a schematic diagram showing the interaction between an application layer and a kernel layer in a conventional operating system;

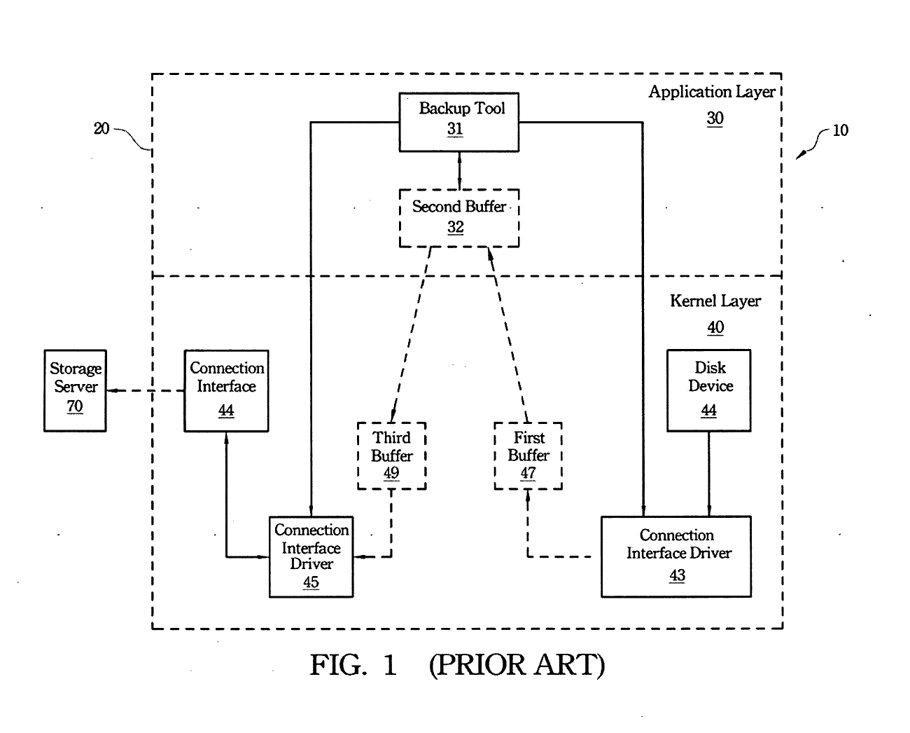

FIG. 2 is a schematic diagram showing the interaction between an application layer and a kernel layer in an operating system according to an embodiment of the present invention; and

FIG. 3 is a schematic flow chart showing a method for backing up data of a server machine according to the embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

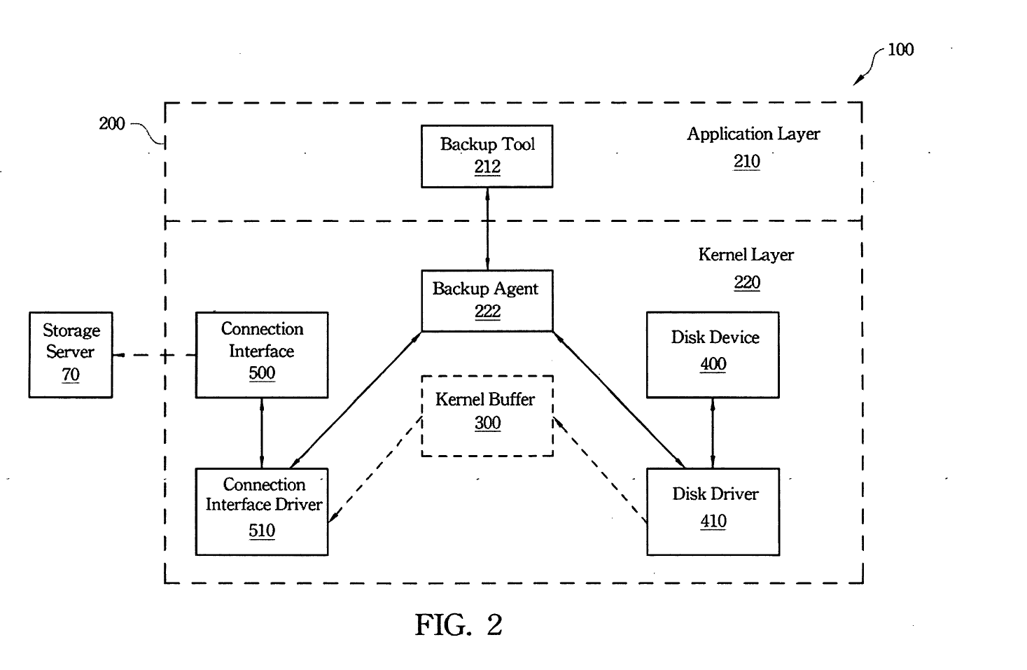

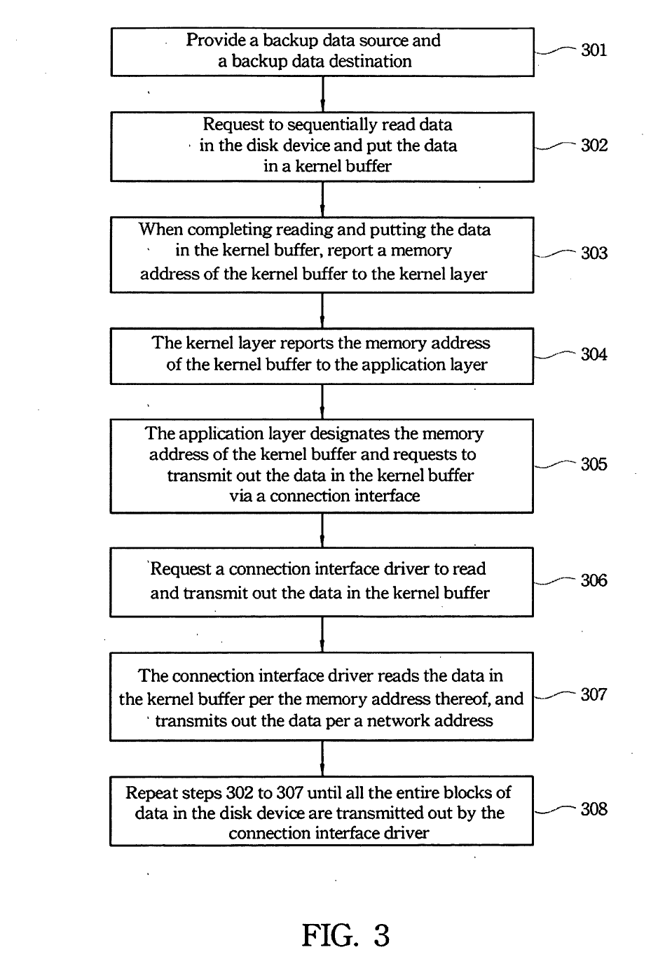

The present invention provides a method for backing up data of a server machine. Such as shown in FIG. 2, FIG. 2 is a schematic diagram showing the interaction between an application layer and a kernel layer in an operating system according to an embodiment of the present invention. In on embodiment, a server machine 100 (such as a network storage apparatus, a network-attached storage server, etc.) has a Linux operating system 200, a backup too, 212, a backup agent 222, a disk driver 410, a connection interface driver 510 and a kernel buffer 300. The backup tool 212 is defined in an application layer 210 of the Linux operating system 200, and the disk driver 410, the connection interface driver 510 and the kernel buffer 300 are defined in a kernel layer 220 of the Linux operating system 200. Thus, when the backup tool 212 of the application layer 210 requests the backup agent 222 to back up data of the server machine 100 to another server machine 170 (such as a network storage apparatus, a network-attached storage server, etc.), the backup agent 222 requests the kernel layer 220 to duplicate the data of the server machine 100, and to put the data in the kernel buffer 300 of the kernel layer 220, and thereafter, the backup agent 222 requests the kernel layer 220 to read the identical data in the kernel buffer 300, thereby directly transmitting the data to the server machine 170. More concretely, referring to FIG. 2 and FIG. 3, FIG. 3 is a schematic flow chart showing a method for backing up data of a server machine according to the embodiment of the present invention. The steps of this embodiment are described in detail as follows.

In step 301, the backup tool 212 provides a backup data source (i.e. a location path of the disk device 400; hereinafter, the backup data source is referred to as the disk device 400) and a backup data destination (i.e. a network address of the server machine 170), and then requests the backup agent 222 to transmit the data in the disk device 400 to the server machine 170.

Then, in step 302, the backup agent 222 requests the disk driver 410 associated with the disk device 400 to sequentially read the first to nth blocks of data in the disk device 400, and to sequentially put each of the blocks of data in one (for example, the kernel buffer 300) of the buffers at the kernel layer 220, wherein each block of data is not limited to being put in the same kernel buffer 300.

In step 303, when completing reading and putting one of the blocks of data in the kernel buffer 300, the disk driver 410 reports a “completion” message and a message regarding “a memory address of the kernel buffer is 300” to the backup agent 222 at the kernel layer 220

In step 304, after receiving the report from the disk driver 410, the backup agent 222 of the kernel layer 220 merely reports the “completion” message and the message regarding “a memory address of the kernel buffer 300” to the backup tool 212 of the application layer 210, and does not need to duplicate the data in the kernel buffer 300 to a buffer (not shown) of the application layer 210 for use by the backup tool 212.

In step 305, the backup tool 212 designates the memory address of the kernel buffer 300, and requests the backup agent 222 to transmit the data in the kernel buffer 300 to the server machine 170 via the connection interface 500 (such a network interface using a fibre protocol, an iSCSI protocol or a SAS protocol).

In step 306, the backup agent 222 provides the memory address of the kernel buffer 300 and the network address of the server machine 170, and requests the connection interface driver 510 of the connection interface 500 to read and transmit out the data in the kernel buffer 300.

In step 307, the connection interface driver 510 reads the data in the kernel buffer 300 in accordance with the memory address of the kernel buffer 300, and transmits the data in the kernel buffer 300 to the server machine 170 in accordance with the network address of the server machine 170.

In step 308, steps 302 to 307 are repeated until all the blocks of data in the disk device 400 pass through one kernel buffer 300 and are transmitted to the server machine 170 via the connection interface 500 by using the connection interface driver 510.

Consequently, the aforementioned embodiment may simplify the procedure for duplicating data back and forth between the kernel layer and the application layer, so that the kernel buffer 300 provided for the disk driver 410 to put blocks of data can be directly used as the buffer required by the connection interface driver 510, thereby saving the time for duplicating blocks of data to the buffer of the application layer 210 and then back to the buffer of the kernel layer 220 by merely reporting the “completion” message and the message regarding the memory address of the kernel buffer 300. For quite an immense amount of data in a storage server (server machine), there is no doubt that the embodiment can doubly improve the efficacy for backing up data in the server machine 100 to another server machine 170.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for backing up data of a server machine, the server machine owning an operating system having a kernel layer and an application layer, wherein, when the application layer requests a backup agent at the kernel layer to back up data in the server machine to another server machine, the method comprises:
requesting, by the backup agent, the kernel layer to duplicate data in a disk device and put the data in a kernel buffer at the kernel layer; and
requesting, by the backup agent, the kernel layer to directly read the data from the kernel buffer and transmit the data to the another server machine.

2. The method as claimed in claim 1, wherein, when the application layer requests the backup agent at the kernel layer to back up data in the server machine to the another server machine, the method further comprises:
providing, by a backup tool at the application layer, a backup data source and a backup data destination, wherein the backup data source is a location path of the disk device, and the backup data destination is a network address of the another server machine; and
then requesting, by the backup tool, the backup agent to transmit the data in the disk device to the another server machine via a connection interface.

3. The method as claimed in claim 2, wherein, when the backup agent requests the kernel layer to duplicate the data in the disk device and put the data in the kernel buffer, a disk driver associated with the disk device sequentially reads a plurality of blocks of data in the disk device, and sequentially puts each of the blocks of data in the kernel buffer.

4. The method as claimed in claim 3, wherein, when the disk driver completes reading and putting one of the blocks of data, the disk driver reports a memory address of the kernel buffer to the backup agent.

5. The method as claimed in claim 4, wherein, when the backup agent requests the kernel layer to directly read the data from the kernel buffer and transmit the data to the another server machine, the method further comprises:
reporting, by the backup agent, the memory address of the kernel buffer to the backup tool without duplicating the data in the kernel buffer to the application layer.

6. The method as claimed in claim 5, wherein, when the backup tool requests the backup agent to transmit the data in the disk device to the another server machine via the connection interface, the method further comprises:
designating, by the backup tool, the memory address of the kernel buffer, and requesting, by the backup tool, the backup agent to directly transmit the data in the kernel buffer to the another server machine via the connection interface.

7. The method as claimed in claim 6, wherein, when the backup agent requests the kernel layer to directly read the data from the kernel buffer and transmit the data to the another server machine, the method further comprises:
directly reading, by a connection interface driver of the connection interface, the data in the kernel buffer in accordance with the memory address of the kernel buffer; and
transmitting, by the connection interface driver, the data to the another server machine in accordance with the network address of the another server machine.

8. The method as claimed in claim 1, wherein the server machine is a network storage apparatus.

9. The method as claimed in claim 1, wherein the operating system is Linux operating system.

10. The method as claimed in claim 1, wherein the connection interface is a network interface using a fibre protocol, an iSCSI (Internet SCSI (Small Computer System Interface)) protocol or a SAS (Serial Attached SCSI) protocol.
